(19) United States
(12) Patent Application Publication
(10) Pub. No.: US 2014/0267395 A1
(43) Pub. Date: Sep. 18, 2014

(54) LOW-LATENCY INTERACTIVE MULTIVIEWER INTERFACES AND METHODS FOR VIDEO BROADCAST EQUIPMENT

(71) Applicant: ROSS VIDEO LIMITED, Iroquois (CA)

(72) Inventors: David Allan ROSS, Nepean (CA); Leslie Vincent O'Reilly, Ottawa (CA); Troy David English, Ottawa (CA); Gary Kevin Cook, Kanata (CA); James Lee Peltzer, Ottawa (CA); Alun John Fryer, Stittsville (CA)

(73) Assignee: ROSS VIDEO LIMITED, Iroquois (CA)

(21) Appl. No.: 13/798,994

(22) Filed: Mar. 13, 2013

(51) Int. Cl. G09G 5/377

(52) U.S. Cl. CPC G09G 5/377
USPC 345/633

(57) ABSTRACT

Low-latency interactive multiviewer interfaces and methods for video broadcast equipment are disclosed. A video switcher includes an integrated multiviewer to generate a multiviewer interface. Video signals are received from video sources and a user interface graphic is received from an external source such as an external computer. The received video signals are routed in a video path of the video switcher to be presented in a multiviewer interface on a display, and the received interface graphic is overlaid on the received video signals for presentation in the multiviewer interface. Realtime elements associated with frames of the video signals may also be generated within the video switcher and combined with the video signals and the externally generated interface graphic in the multiviewer interface. The video signals could include video signals from external video sources, outputs of internal processing elements within the video switcher, and/or intermediary video signals within the video switcher.

### FIELD OF THE INVENTION

The present invention relates to the field of professional and broadcast video systems.

### BACKGROUND

In a typical broadcast studio, it is commonplace to require a number of video monitors such that the production personnel may view different video signals simultaneously. These signals may include video feeds, or sources, such as studio cameras, video playback devices, graphics workstations, remote camera feeds, satellite feeds, and so on. Additional monitors are required to display the program, preview and other signals generated by a production switcher in the studio. It is also common for monitors to be allocated to intermediary signals to be displayed, for example Multi-Level Effects (MLE) 1 program, preview and auxiliary buses. More complex productions typically require a larger number of these video monitors, as they usually work with more video sources and video outputs.

Previously, it was quite common for a studio to incorporate a monitor wall, consisting of multiple, often dozens, of discrete Cathode Ray Tube (CRT) video monitors stacked in a fashion that formed a wall of video displays directed at the production personnel. As display technology evolved, CRT monitors were replaced with discrete flat panel display (FPD) devices such as Liquid Crystal Display (LCD) or plasma display screens.

Further advances introduced multi-display devices, or multiviewers, which allow the display of multiple video windows on a display device, as taught for example in U.S. Pat. No. 5,642,498. These multiviewers utilize video scaling technology to resize individual video images and place them in a layout, typically a grid layout, on a single display monitor. Multiviewers have evolved with the advancement of computing technology, and allowed the addition of graphic elements to present supplementary information, such as clocks, audio meters, and video metadata. United States Patent Application Publication No. 2009/0256835, for example, teaches a video multiviewer system for generating video data based upon multiple video inputs with added graphic content, using a Graphics Processing Unit (GPU) to create the additional graphic elements and provide the final video data to a display.

Stand-alone multiviewer devices are typically fed video sources such as cameras, graphics generators, and video servers in addition to outputs of production equipment, including a production switcher. Typically, distribution and routing of these signals require the introduction of distribution amplifiers and additional cabling.

Traditional control of broadcast production equipment, such as production switchers or Digital Video Effects (DVE) devices, has traditionally employed a “lean-back” approach, where large, customized control surfaces were placed at each operator position. An operator would typically sit in a “lean-back” position using their hands to operate the equipment, while simultaneously looking forward and up at the monitor wall or multiviewers. Further advances in control surfaces integrate Graphical User Interfaces (GUIs) to provide more flexible controls to the operator.

Lean-forward controls aim to place all of the focus of the operator on a nearby display, using nearby controls. This keeps focus of the operator in a small area, thus reducing the loss of response time that can be incurred through a shift of focus in lean-back systems. Lean-forward systems may employ a combination of local display devices, GUI, keyboards, mouse, touchscreens or other customized control surfaces. International (PCT) Publication No. 2004/088978 teaches a broadcast control apparatus where a touch screen display panel is used to display visual data from a plurality of visual sources and a touch screen graphical panel is used for retrieval of control functions from a control function register.

Some GUI interfaces may present video windows displaying certain video signals through what is known as proxy video. Proxy video, or “proxies” as they are also known in the broadcast industry, are smaller, lower-resolution duplicates of a video signal. These may be created by manipulation by hardware, Field Programmable Gate Array (FPGA), Application Specific Integrated Circuit (ASIC) or software algorithms performed on the original video signal. Proxies may also undergo video compression, in accordance with Moving Picture Experts Group (MPEG), ITU-T Video Coding Experts Group (VCEG), or Joint Photographic Experts Group (JPEG) standards such as MPEG-2, h.264, JPEG2000 or the like. Finally, the proxies are then transferred to a GUI screen. In some implementations, the GUI screen is connected to a separate computing device, and hence the proxies must be transmitted via a network interface.

### SUMMARY

A video switcher includes: an input to receive video signals from video sources and a user interface graphic from an external source; a video path for the received video signals from the video sources to be presented in a multiviewer interface on a display; an overlay module to overlay the received interface graphic on the received video signals for presentation in the multiviewer interface.

The video signals could include one or more of: video signals from external video sources, outputs of internal processing elements within the video switcher, and intermediary video signals within the video switcher.

In an embodiment, the interface graphic includes graphics representing a graphical user interface.

The graphical user interface could include graphical control elements to trigger commands to one or more of: the video switcher and external equipment.

The received video signals could be integrated into live video windows in the multiviewer interface, with the live video windows being integrated into the graphical user interface as graphical control elements to trigger commands to one or more of: the video switcher and external equipment.

The display could include a touchscreen monitor.

In an embodiment, the video path includes a crosspoint switch, operatively coupled to the input and to the overlay module, to route the received video signals and the user interface graphic.

The video path could also include a video scaler, coupled to the crosspoint switch, to scale the received video signals. In an embodiment, the video path further includes: a framebuffer, coupled to the video scaler, to store graphic overlay information and scaled video signals from the video scaler; a realtime graphic overlay module, coupled to the framebuffer and to the overlay module, to read frames of the scaled video signals and the graphic overlay information associated with each frame from the framebuffer, to generate a frame-accurate realtime graphic overlay that includes the frames of the scaled video signals and the graphic overlay information read from the framebuffer, and to provide the realtime graphic overlay to the overlay module for further overlay of the received interface graphic.

A method is also provided, and includes: receiving, in a video switcher, video signals from video sources; receiving, in the video switcher, a user interface graphic from an external source; routing the received video signals in a video path of the video switcher, to be presented in a multiviewer interface on a display; overlaying the received interface graphic on the received video signals for presentation in the multiviewer interface.

The video signals could include one or more of: a video signal from an external video source, an output of an internal processing element within the video switcher, and an intermediary video signals within the video switcher.

As noted above, the interface graphic could include graphics representing a graphical user interface. The graphical user interface could include graphical control elements to trigger commands to one or more of: the video switcher and external equipment.

The method could also involve: integrating the received video signals into live video windows in the multiviewer interface, and integrating the live video windows into the graphical user interface as graphical control elements to trigger commands to one or more of: the video switcher and external equipment.

The display on which the multiviewer interface is to be presented could include a touchscreen monitor.

In an embodiment, the routing involves routing the received video signals in a crosspoint switch.

The method could also include scaling the received video signals in the video path, and in an embodiment the method further involves: generating, in the video path, a realtime graphic overlay comprising scaled video signals, in which case the overlaying could include overlaying the received interface graphic on the realtime graphic overlay.

Such a method could be implemented using a non-transitory computer-readable medium storing instructions which, when executed, perform the method.

According to another aspect, a video switcher includes: an input to receive video signals from video sources and a user interface graphic from an external source; a Central Processing Unit (CPU) to draw realtime graphical elements associated with frames of one or more of the received video signals; an overlay module to overlay the received interface graphic on the received video signals and realtime graphical elements for presentation in a multiviewer interface.

Other aspects and features of embodiments of the present disclosure will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 illustrates an example multiviewer interface.

FIG. 2 is a block diagram of a multiviewer system.

FIG. 3 is a block diagram that illustrates transmission of live video sources to a GPU in a multiviewer.

FIG. 4 is a flow diagram illustrating an example of video data flow through a multiviewer.

FIG. 5 is a block diagram that illustrates another type of transmission of live video sources to a GPU in a multiviewer.

FIG. 6 is a flow diagram illustrating an example of video data flow through a multiviewer using direct memory access from a framebuffer to a GPU.

FIG. 7 is a block diagram of an example video production system.

FIG. 8 is a block diagram of an example multiviewer for integration into a video switcher.

FIG. 9 is a flow diagram illustrating an example of video data flow through an integrated multiviewer.

FIGS. 10 and 11 illustrate an example of a multiviewer graphical user interface.

FIG. 12 is a flow diagram illustrating an example method.

### DETAILED DESCRIPTION

Several types of broadcast video systems and techniques are described in the Background section above.

Multiviewer systems that use GPUs may allow for greater flexibility in the composition of live video windows and graphic elements, but they also introduce significant processing latency, which is undesirable. These types of systems and related methods may also rely upon a relatively narrow-bandwidth interface to feed video sources to the GPU, thereby limiting the number of live video sources which may be composited in this manner.

Lean-back systems disadvantageously cause the operator to shift focus from a distant monitor wall to the control surfaces, which can lead to a greater number of errors by the operator and reduce responsiveness of the operator. Although GUIs provide more flexible controls to the operator, a GUI lacks the tactile properties of a fixed control surface, eliminating the possibility of the operator locating the desired controls by tactile feedback or touch. The operator therefore might shift focus between the nearby GUI and the distant monitor wall or multiviewer interface even more frequently.

In systems involving workstations that coordinate control of multiple pieces of broadcast equipment remotely, there can be latency issues in video windows and in control paths.

Latency can also be problematic in transmission of proxies to computing devices. For example, such transmission disadvantageously introduces significant latency to the proxy video presented in a video window on a GUI display. Furthermore, this transmission of proxies may consume significant network bandwidth and require significant processing by the computing device which presents the GUI display.

Algorithms used to generate compressed proxy video and network transports in many cases have indeterminate processing and delivery times. The processing latency of some compression algorithms is determined by actual video content, and thus the time required to produce the proxy video may vary. Many network transport methods (such as User Datagram Protocol (UDP), for example) do not guarantee delivery, and thus are subject to data loss. This could result in dropped video frames in a proxy video. Furthermore, network transport methods might not guarantee the time required to deliver information. This introduces further indeterminacy in the latency of the proxy video as displayed on a GUI screen.

In accordance with an aspect of the present disclosure, an interactive graphical user interface incorporates a plurality of low-latency live video windows. An interactive user interface could include a graphical user interface displayed on a touchscreen monitor. This graphical user interface could be further enhanced by inserting live video windows, to provide realtime feedback to the operator as to the current state of a plurality of video sources, in a low-latency manner so as to provide realtime deterministic feedback of the video content.

Video switchers, such as video production switchers and master control switchers, are devices which allow several video signals to be combined together, and several audio signals to be combined together, in a variety of manners to assemble at least one program video and audio output. Often, different types of audio and video effects are used when these signals are assembled. For example, one video source may fade, or “dissolve” to another; one video source may be “wiped” to another, or one audio stream may fade out as another fades in. A switcher may also generate additional video and audio outputs such as preview, clean feed, aux buses, and so on. Each of these outputs could also include multiple video source signals assembled together with various audio-visual effects.

In a studio environment, it is often necessary to monitor several video signals simultaneously. These signals may include signals from video sources such as, for example, studio cameras, videotape players, videodisc players, video servers, graphics, remote camera feeds and satellite feeds. Additionally, it is often necessary to monitor the output of the switcher, as the program video is assembled. Furthermore, preview, clean feed, aux buses and so on are also monitored in the studio. A multiviewer is a commonly used apparatus that can assemble multiple such video signals from various video sources onto a single video display. It is common for a broadcast studio to employ multiple such multiviewers to display a large number of video source signals.

FIG. 1 illustrates an example multiviewer interface 101, wherein a single display device, such as an LCD, plasma or similar device, presents multiple live video windows 102, 104, 106-111. Multiviewers may also provide additional information, for example time-of-day clock 112, date, time and timecode 113 and audio meters 114. Some multiviewers allow graphic information to be overlaid on top of the video windows, for example source name and on air status 103, 105. Semi-transparent alpha-blending is sometimes used to present this information. Some multiviewers will generate video for multiple distinct physical display devices, allowing the number of video windows and additional information to be increased.

FIG. 2 is a block diagram of a multiviewer system 100, and illustrates a simplified view of a typical multiviewer application in a broadcast studio. The multiviewer 204 is typically connected to one or more display devices 205, whereupon multiple video sources are displayed. The multiviewer 204 is a stand-alone device with multiple video inputs 209, 213 and one or more video outputs 210. In order to provide video signals from primary video sources 211 to the multiviewer 204, it is necessary to fan-out the signals via distribution amplifiers 202. The source signals are then fed into the multiviewer as shown at 213 and the switcher 203 as shown at 212. Additionally, in order to provide program, preview, clean feed, aux buses and the like to the multiviewer 204, outputs of the switcher 203 are also fed into the multiviewer as shown at 209. It is also necessary to provide a common timing reference to all video equipment, so connection to a video reference generator 206 is typically used, and a common timing reference is fed from the video reference generator to the distribution amplifiers 202 over a connection 216, to the switcher 203 over a connection 214, and to the multiviewer 204 over a connection 215.

Within the multiviewer 204, there is significant processing latency. FIG. 3 is a block diagram that illustrates transmission of live video sources to a GPU in a multiviewer. Video inputs are captured into a dedicated framebuffer/capture card 31. In some implementations, images are scaled or partially scaled within the framebuffer/capture card 31. See, for example, United States Patent Application Publication No. 2009/0256862. The advantage of pre-scaling is that it reduces the quantity of video data to be transferred via the system bus 35, but disadvantageously adds additional latency for the scaling operation. Video data is transferred to the system memory 33 via the system bus 35 and CPU 32. It is then transferred from the system memory 33 via the CPU 32 and system bus 35 to the GPU 34, whereupon the live video signals are composited with other graphical elements and then the resultant multi-image video signal is transmitted to a suitable display device. This approach will introduce a latency of at least 4 video frames to the live video streams, but may be much longer, depending upon the complexity of the multiviewer's internal processing and the processing latency of the display devices used. FIG. 4 is a flow diagram illustrating an example of video data flow through a multiviewer as described with reference to FIG. 3, and also shows the associated latency as video frame delays.

This latency can be partially reduced by implementation of direct memory access (DMA) transfer directly from the framebuffer/capture card to the GPU. See, for example, United States Patent Application Publication No. 2009/0259775. FIG. 5 is a block diagram that illustrates another type of transmission of live video sources to a GPU in a multiviewer, using DMA transfer. As with the previous approach described above with reference to FIGS. 3 and 4, live video streams are captured into a dedicated framebuffer/capture card 51. In some implementations, images are scaled or partially scaled within the framebuffer/capture card 51. Video data is transferred to the GPU 54 via the system bus 55 via a DMA transfer, without involving the CPU 52 or the system memory 53. Although this approach has improved latency, it still introduces a minimum of 3 video frames latency to the live video streams, and the latency could be much longer, depending upon the complexity of the multiviewer's internal processing and the processing latency of the display devices used. FIG. 6 is a flow diagram illustrating an example of video data flow through a multiviewer as described with reference to FIG. 5, and also shows the associated latency as video frame delays. Furthermore, practical limitations on the bandwidth available on the system bus 55 limit the number of video signals that may be transferred.

Due to video path latencies and other limitations, these types of systems are not suitable for accurate, realtime interactive control systems. As disclosed herein, latency of the live video signals can potentially be reduced, to provide realtime, or near realtime, and deterministic feedback to an operator as to the current states of video sources.

FIG. 7 is a block diagram of an example video production system. The example video production system 700 includes an external computer 701, a video switcher 703 such as a production switcher or a master control switcher, a display 705, a video reference generator 722, a High Definition Multimedia Interface (HDMI) to Serial Digital Interface (SDI) converter 724, and an SDI to HDMI converter 726, interconnected as shown at 706, 707, 708, 709, 710, 712, 713, 714.

Although the example shown in FIG. 7 includes only one external computer 701, other embodiments could include multiple external computers that generate GUI graphics. An external computer 701 could also or instead generate and provide multiple GUI graphics to the switcher 703. Thus, multiple GUI graphics could be generated by one or more external computers such as 701 for overlay onto video signals in the switcher 703 to provide one or more multiviewer interfaces.

The HDMI to SDI converter 724 and the SDI to HDMI converter 726 convert video signal formats for input to the switcher 703 from the computer 701 and for output from the switcher for presentation on the display 705. These could be separate components as shown or integrated into the switcher 703. In this example, the computer 701 outputs HDMI signals, the display 705 receives HDMI input signals, and the switcher 703 handles SDI input and output signals. Other signal combinations are also contemplated, and different types of converters, or no converters where signal formats are consistent in a system, could be used in other embodiments.

It should also be noted that the arrows on the connections at 706, 707, 708, 709, 710, 712, 713, 714 represent directions of data or control flow in an embodiment. The connections at 707, 708, 709, 710, 712, 713, 714 are not necessarily unidirectional, and the control connection 706 is not necessarily bidirectional.

More generally, the example video production system 700 of FIG. 7, as well as the contents of the subsequent drawings, are intended solely for illustrative purposes, and the present disclosure is in no way limited to the particular example embodiments explicitly shown in the drawings and described herein.

The display 705 and the video reference generator 722 in FIG. 7 could be the same as the display 205 and the video reference generator 206 in FIG. 2. The computer 701 generates a GUI graphic, which is combined with video signals and possibly other graphic content in the switcher 703 to generate a multiviewer interface. This type of signal combining is performed in a separate and external multiviewer 204 in FIG. 2, and in that example it is necessary to provide additional external cabling of video signals at 212, 213, and to route switcher outputs 209 to the multiviewer. Furthermore, external signal distribution amplifiers 202 are also required in FIG. 2 to distribute the incoming video signals 211 to both the switcher 203 and the multiviewer 204. Disadvantageously, some internal signals in the switcher 203 may not be accessible to the multiviewer 204 if the switcher does not allow routing of the internal signals to a video output. As shown in FIG. 7, where the switcher 703 has an integrated multiviewer and graphic overlay capability, video sources at 711 are fed into the switcher 703 without additional distribution amplifiers or cabling.

Several control paths 706, 714 are illustrated in FIG. 7. The control path 706 between the computer 701 and the switcher 703 could enable the computer to be controlled by the switcher to change GUI graphic layout and/or content, for example. Layout and content changes could also or instead track the other way, with the control path enabling the computer 701 to instruct the integrated multiviewer in the switcher 703 to modify the layout of the multiviewer interface to track with GUI graphic layout changes occurring in the computer. This control path 706 might also or instead enable a user to control certain video production functions of the switcher 703 from the computer 701. The display 705 could be a touchscreen display in an embodiment, allowing the user to provide control inputs through the multiviewer GUI, with corresponding control signals then being provided to the computer 701 over the control path 714. From the perspective of the computer 701, these control signals could be treated as though they were received from one of the computer's own user interface devices. Other user interface devices such as a keyboard and/or a mouse for example, could also or instead be used to provide user inputs to the computer 701 over the path 714. Thus, the display 705 could be a stand-alone touchscreen display in some embodiments, and/or have its own associated user interface devices in other embodiments.

FIG. 8 is a block diagram of an example multiviewer for integration into a video switcher. The example production switcher-integrated multiviewer 800 includes a crosspoint switch 801, a video scaler 803, control logic 804, a framebuffer 805, a CPU interface 806, a realtime graphic overlay module 807, a GUI overlay module 808, and a frame synchronizer 809, interconnected as shown.

In general, hardware, firmware, components which execute software, or some combination thereof might be used in implementing the components shown in FIG. 8. Electronic devices that might be suitable for implementing any or all of these components include, among others, microprocessors, microcontrollers, Programmable Logic Devices (PLDs), FPGAs, ASICs, and other types of “intelligent” integrated circuits.

The internal crosspoint switch 801 allows routing of video signals 811 from external video sources, video signals 812 from internal source(s), for example MLE program, preview, clean feed, aux buses, and/or other intermediary video signal(s) 813 that exist within a switcher. In the example shown, the crosspoint switch 801 allows routing of a plurality of video signals 802, which could be of any number based upon the implementation, to the video scaler 803. The video scaler 803 resizes the individual video images to a desired size, based upon a pre-determined layout of the multiviewer interface. The present disclosure is not limited by a singular system bus, as the number of video interconnections within a switcher could be arbitrarily scaled up to the number of desired video signals.

The crosspoint switch 801 also selects one of the plurality of external video sources 811, predetermined to carry the GUI graphic for the multiviewer interface, and feed this to the frame synchronizer 809. This frame synchronizer 809 temporally aligns the GUI graphic to match the desired timing of the switcher multiviewer output 810. In some implementations, this frame synchronizer 809 could also incorporate a format converter, allowing GUI graphics of different sizes or formats from the native video format to be converted to the desired format of the display device that receives the output 810 and displays the multiviewer interface. In some implementations, the frame synchronizer 809 might not be incorporated into the switcher at all, and could optionally be implemented with an external apparatus. In some implementations, a frame synchronizer 809 is not used, and the GUI graphic source could be timed to a common video reference, as shown in FIG. 7 for instance.

The resized images from the video scaler 803 are then fed into the framebuffer 805. Control logic 804 manages the writing and reading of the framebuffer 805 such that each resized video image is read out of the framebuffer as a single video image, with the scaled images arranged in the desired layout of the multiviewer interface.

It should be noted that the video scaler 803, control logic 804 and framebuffer 805 are shown for illustrative purposes only, and that the present disclosure does not preclude alternative video resizing methods.

Simultaneously to the video resizing process, supplementary graphical information could be drawn into another region of the framebuffer 805, illustratively by a switcher CPU (not shown) via the CPU interface 806. This supplementary graphical information or content could include, but is not limited to, one or more of on-air tally information, source image name, audio metering, timecode displays and so on. The switcher CPU draws such elements to ensure a realtime correlation to the video signals themselves. Additionally some information, for example timecode or audio levels, could be extracted directly from one or more of the video signals, and as such the extracted information is aligned with the corresponding video signals for feeding into the framebuffer 805 in this example.

Information such as timecode, audio levels, etc. could be extracted from metadata in a video signal itself, or such information may also or instead come from other sources, such as a serial interface, Global Positioning System (GPS) for accurate time of day, satellite, etc. This extracted metadata can then be read, and an appropriate graphic element can be drawn to the framebuffer 805 through the CPU interface 806. for example. The realtime CPU in the switcher can ensure the deterministic latency of these displays, as all processes are of deterministic latency of known durations to the CPU. That is to say, the audio information (for example) presented on an audio meter is frame-accurate to the video being displayed. It should be noted that this type of extraction and display is not limited to having the switcher CPU do the actual drawing of graphic elements. Other hardware, components that execute software and/or processing elements could be engaged to do the actual graphic rendering. The realtime CPU, however, is controlling exactly what is drawn and when in this example. This is distinct from the GUI graphic generated by the external computer, as that GUI graphic might not necessarily be realtime relative to the video signals. This is the nature of computer-generated GUIs. In a sense, some embodiments could be seen as combining a complex UI generated by an external computer with realtime elements generated by a switcher itself.

The realtime graphic overlay module 807 reads multiviewer interface content from the framebuffer 805, assembles a video layout, illustratively a grid, with overlaid realtime video and possibly other additional graphic elements, and feeds this into the GUI overlay module 808, where the GUI graphic is overlaid over the video layout. Transparency of the overlay is determined by analysis of the GUI graphic in an embodiment and this could employ techniques such as, but not limited to, luminance keying or chroma-keying. The GUI graphic is overlaid over the multiviewer layout, as this allows all graphic elements, including for example, cursors, or supplementary information, decoration and mouse pointers, to be visible, even if they should be located within the region of a live window. In some existing systems, the video windows are overlaid on top of the graphic background, which would obscure any graphic elements that may appear within the region of a video window, including for example, cursors, supplementary information, decoration, and mouse pointers.

Embodiments of the present disclosure could provide a significant reduction in the latency of the live video output in a multiviewer interface relative to existing multiviewer systems. The techniques disclosed herein, involving integration of multiviewer generation into a switcher, can reduce latency to a little as 1 video frame. This can be especially important in time-sensitive operations where reaction to the live video is required. Video latency is also deterministic in some embodiments.

FIG. 9 is a flow diagram illustrating an example of video data flow through an integrated multiviewer, and illustrates a single frame delay associated with framebuffering in an embodiment.

By reducing the latency of the live video windows, it is operationally feasible to integrate the multiviewer display into an interactive graphical user interface. Some embodiments also or instead utilize a touchscreen interface, allowing the GUI elements and live video windows to be touched to provide control commands to the system, as illustrated at 714 in FIG. 7 for example.

According to a further aspect of the present disclosure, the GUI graphic is provided for the multiviewer interface as an input to the switcher. This allows GUI graphic elements to be drawn by an independent computing or video device, such as the computer 701 in FIG. 1. Thus, a switcher does not rely upon the computing power of a CPU or GPU integrated into a multiviewer, as in existing systems. Conversely, it allows low-power, compact and/or portable devices to be used to generate the GUI graphic. In addition, the GUI graphic for the multiviewer interface is combined with video signals within the switcher itself instead of externally, and the video signals in the resultant multiviewer interface are therefore in realtime or near realtime and more closely reflect the actual states of video sources.

Furthermore, as the GUI graphic could be generated by an external device, a device which is capable of additional control or processing functionality could be employed to generate this GUI graphic. For example, a system which provides control to other broadcast equipment, such as video servers, graphics systems, character generators, automation systems and so on, could be used. The external system that generates the GUI graphic could even implement processing functions for graphics systems, character generators, and/or video servers for instance.

Embodiments of the present disclosure could also improve upon proxy video methods. Since video is fed directly to the integrated multiviewer, it does not have the associated overhead of heavy video compression and network transport of the live video displayed on the GUI in proxy video systems. Furthermore, the large latency penalties of compression, network transport and decompression for proxy video systems are not incurred. The display of live video in accordance with teachings of the present disclosure has low and deterministic latency, whereas prior proxy video methods may have indeterminate latency due to fluctuations in the processing time for software algorithms and network transport. Also, embodiments of the present disclosure internally deliver video to the GUI within a switcher, providing a better assurance of delivery. Finally, the facility in which a video production system is installed does not need to provide additional network infrastructure to support the delivery of proxy video from the source video to the GUI computing device where a switcher integrates multiviewer interface generation.

As noted above with reference to FIGS. 7 and 2, an integrated multiviewer interface generation solution avoids additional external cabling for routing video signals as shown in FIG. 2 at 212, 213 and switcher outputs 209, and also avoids the external signal distribution amplifiers 202 to distribute the incoming video signals 211 to both the switcher 203 and multiviewer 204. With a separate multiviewer 204, some internal signals in the switcher 203 might not be accessible to the multiviewer if the switcher does not allow routing of the signal to a video output. With an integrated solution, output video signals of the switcher, and/or intermediary signals of the switcher can be routed to and included in the multiviewer interface internally, without restriction.

A multiviewer interface could be presented on a touchscreen display, in conjunction with a communication path to feed user input from the touchscreen GUI back to the switcher 703, providing a fully-interactive, tactile, user interface with live video feedback. Such a path is represented in part in FIG. 7 at 714. User inputs received through the multiviewer interface on the display 705 are provided to the computer 701, which in turn provides control signals to the switcher 703 on the control path 706 to perform functions as selected by the user.

FIGS. 10 and 11 illustrate an example of such a multiviewer graphical user interface 1000. A single touchscreen display device could incorporate live video windows as shown in FIG. 10 at 1001, 1002, and GUI graphical control elements as shown at 1003, 1004. Both the live video windows 1001, 1002 and the GUI graphical control elements 1003, 1004 could be configured to be selectable by a user via a pointing device such as a mouse, by a keyboard, and/or by touch to the touchscreen directly, to initiate a command action to software in an embodiment, such as control software running on an external computer 701 (FIG. 7). The software could then use these commands to provide control actions or status updates to the switcher 703, and/or possibly other connected equipment, to perform actions as directed by the user input. The switcher 703 (FIG. 7) or other connected equipment could also provide information, feedback and/or commands to the software, which in turn could then update the GUI in response thereto. FIG. 10 generally illustrates an example layout of a multiviewer interface, and FIG. 11 is a screen shot in which the live video windows 1001, 102 and GUI graphical control elements 1003, 1004 are populated.

Thus, as disclosed herein, a video switcher such as the switcher 703 (FIG. 7) could include an integrated multiviewer such as the example multiviewer 800 (FIG. 8). The video switcher has an input to receive video signals such as 811, 812, 813 from video sources and a user interface graphic from an external source. This input could be an input to a crosspoint switch 801 as shown in FIG. 8. The switcher also includes a video path for the received video signals from the video sources to be presented in a multiviewer interface on a display, and an overlay module such as 808 to overlay the received interface graphic on the received video signals for presentation in the multiviewer interface.

As shown at 811, 812, 813, the video signals could include video signals 811 from external video sources, outputs 812 of internal processing elements within the video switcher, and intermediary video signals 813 within the video switcher.

The GUI graphic described above and shown in FIG. 8 as an output of the frame synchronizer 809 is an example of an interface graphic that includes graphics representing a GUI. This GUI could include graphical control elements such as 1003, 1004 to trigger commands to the video switcher and/or external equipment, such as the external computer 701 shown in FIG. 7. The received video signals could be integrated into live video windows such as 1001, 1002 in the multiviewer interface, and the live video windows could be integrated into the GUI as graphical control elements to trigger commands to the video switcher and/or external equipment.

The display, such as the display 705 in FIG. 7, could be a touchscreen monitor to receive inputs from a user.

In the example multiviewer 800 (FIG. 8), the video path includes the crosspoint switch 801, which is operatively coupled to the input and to the overlay module 808, to route the received video signals 811, 812, 813 and the user interface graphic. The video path in this example multiviewer also includes a video scaler 803, coupled to the crosspoint switch 801, to scale the received video signals, the framebuffer 805 coupled to the video scaler to store graphic overlay information and scaled video signals from the video scaler, and the realtime graphic overlay module 807. The realtime graphic overlay module 807 is coupled to the framebuffer 805 and to the overlay module 808, to read frames of the scaled video signals and the graphic overlay information associated with each frame from the framebuffer, to generate a frame-accurate realtime graphic overlay comprising the frames of the scaled video signals and the graphic overlay information read from the framebuffer, and to provide the realtime graphic overlay to the overlay module for further overlay of the received interface graphic.

The present disclosure also encompasses combining realtime and externally generated elements into a user interface. Thus, a video switcher such as 703 could include an input to receive video signals 811, 812, 813 (FIG. 8) from video sources and a user interface graphic from an external source such as the external computer 701 (FIG. 7), and a CPU to draw realtime graphical elements associated with frames of one or more of the received video signals. The realtime graphical elements could include graphical elements respectively associated with different video signal frames, although multiple graphical elements could be associated with a single video signal frame and/or a graphical element could be associated with multiple video signal frames. In the example multiviewer 800 in FIG. 8, the switcher CPU draws the realtime graphical elements to the framebuffer 805 through the CPU interface 806. An overlay module such as 808 is provided to overlay the received GUI graphic on the received video signals and realtime graphical elements for presentation in a multiviewer interface.

Embodiments are described above primarily in the context of example apparatus and interfaces. FIG. 12 is a flow diagram illustrating an example method. The example method 1200 includes receiving 1202, in a video switcher, video signals from video sources, and receiving 1204, in the video switcher, a user interface graphic from an external source. Although shown as separate operations in FIG. 12, the receiving operations could be simultaneous, and both the video signals and the interface graphic could be received by the same component of the video switcher, such as the crosspoint switch 801 in FIG. 8. At 1206, the received video signals are routed in a video path of the video switcher, to be presented in a multiviewer interface on a display, and at 1208, realtime graphical elements could be overlaid on the video signals as described above. At 1210, the received interface graphic is overlaid on the received video signals and realtime graphical elements for presentation in the multiviewer interface.

The example method 1200 is illustrative of one embodiment. Examples of additional operations that may be performed, will be apparent from the description and drawings relating to apparatus and interface implementations, for example. Further variations may be or become apparent.

Aspects of the present disclosure thus bring together a production switcher, a multiviewer, a touchscreen GUI, and integrated live, interactive video windows. Integration of these devices together, as disclosed herein, represents a significant advance over known video production systems.

In one aspect, a computing device such as the computer 701 (FIG. 7) generates a graphical user interface graphic, and transmits it using a standard display interface method, HDMI for example. This graphical user interface signal is converted to a digital video signal, for example SDI, High Definition SDI (HD-SDI) or the like, and synchronized to the video reference source. The resultant video signal is fed into a video input of the video switcher 703.

In another aspect, the video switcher 703 (FIG. 7) incorporates a multiviewer such as the example multiviewer 800 (FIG. 8), which combines a plurality of video signals inside the video switcher into a single composite video signal. These video signals may include video sources input to the switcher, outputs of the switcher's internal processing elements, and/or intermediary video signals within the switcher. Individual live video windows for display within the multiviewer interface are generated using a low-latency scaling method.

In yet another aspect, the graphical user interface is overlaid onto the multiviewer video signal in a low-latency processing path.

A further aspect of the present disclosure could involve transmitting the combined multiviewer interface via a video output of the switcher into a video conversion apparatus to generate a display signal which is compatible with desired display device.

In an embodiment, a touchscreen display could be used as the target display device, with control feedback of the touch interface fed back to the computing device which generates the GUI graphic, allowing the user to touch any combination of computer-generated graphical element and multiviewer-generated video elements to trigger events in control software running on the computing device.

Such control software on the computing device could transmit control signals and/or information to the switcher. Similarly, the switcher could transmit control signals and/or information to the control software on the computing device. The control software on the computing device could then update the GUI graphic in response to the control or information update.

What has been described is merely illustrative of the application of principles of embodiments of the present disclosure. Other arrangements and methods can be implemented by those skilled in the art.

For example, the divisions of functions shown in FIGS. 7 and 8 are solely for illustrative purposes. Other embodiments could include fewer, more, and/or different components than explicitly shown, interconnected in the same or a different order.

Similarly, the example GUI 1000 in FIG. 10 is intended to be illustrative and non-limiting. Other GUI layouts and/or content are possible in other embodiments.

In addition, although described primarily in the context of methods and systems, other implementations are also contemplated, as instructions stored on a non-transitory computer-readable medium, for example.

We claim:

1. A video switcher comprising:
an input to receive video signals from video sources and a user interface graphic from an external source;
a video path for the received video signals from the video sources to be presented in a multiviewer interface on a display;
an overlay module to overlay the received interface graphic on the received video signals for presentation in the multiviewer interface.

2. The video switcher of claim 1, the video signals comprising one or more of: video signals from external video sources, outputs of internal processing elements within the video switcher, and intermediary video signals within the video switcher.

3. The video switcher of claim 1, the interface graphic comprising graphics representing a graphical user interface.

4. The video switcher of claim 3, the graphical user interface comprising graphical control elements to trigger commands to one or more of: the video switcher and external equipment.

5. The video switcher of claim 3,
the received video signals being integrated into live video windows in the multiviewer interface,
the live video windows being integrated into the graphical user interface as graphical control elements to trigger commands to one or more of: the video switcher and external equipment.

6. The video switcher of claim 3, the display comprising a touchscreen monitor.

7. The video switcher of claim 6, the graphical user interface providing graphical control elements to trigger commands to one or more of: the video switcher and external equipment.

8. The video switcher of claim 6,
the received video signals being integrated into live video windows in the multiviewer interface;
the live video windows being integrated into the graphical user interface as graphical control elements to trigger commands to one or more of: the video switcher and external equipment.

9. The video switcher of claim 1, the video path comprising:
a crosspoint switch, operatively coupled to the input and to the overlay module, to route the received video signals and the user interface graphic.

10. The video switcher of claim 9, the video path further comprising:
a video scaler, coupled to the crosspoint switch, to scale the received video signals.

11. The video switcher of claim 10, the video path further comprising:
a framebuffer, coupled to the video scaler, to store graphic overlay information and scaled video signals from the video scaler;
a realtime graphic overlay module, coupled to the framebuffer and to the overlay module, to read frames of the scaled video signals and the graphic overlay information associated with each frame from the framebuffer, to generate a frame-accurate realtime graphic overlay comprising the frames of the scaled video signals and the graphic overlay information read from the framebuffer, and to provide the realtime graphic overlay to the overlay module for further overlay of the received interface graphic.

12. A method comprising:
receiving, in a video switcher, video signals from video sources;
receiving, in the video switcher, a user interface graphic from an external source;
routing the received video signals in a video path of the video switcher, to be presented in a multiviewer interface on a display;
overlaying the received interface graphic on the received video signals for presentation in the multiviewer interface.

13. The method of claim 12, the video signals comprising one or more of: a video signal from an external video source, an output of an internal processing element within the video switcher, and an intermediary video signals within the video switcher.

14. The method of claim 12, the interface graphic comprising graphics representing a graphical user interface.

15. The method of claim 14, the graphical user interface comprising graphical control elements to trigger commands to one or more of: the video switcher and external equipment.

16. The method of claim 14, further comprising:
integrating the received video signals into live video windows in the multiviewer interface,
integrating the live video windows into the graphical user interface as graphical control elements to trigger commands to one or more of: the video switcher and external equipment.

17. The method of claim 14, the display comprising a touchscreen monitor.

18. The method of claim 17, the graphical user interface providing controls to trigger commands to one or more of: the video switcher and external equipment.

19. The method of claim 17, further comprising:
integrating the received video signals into live video windows in the multiviewer interface,
integrating the live video windows into the graphical user interface as graphical control elements to trigger commands to one or more of: the video switcher and external equipment.

20. The method of claim 12, the routing comprising routing the received video signals in a crosspoint switch.

21. The method of claim 20, further comprising:
scaling the received video signals in the video path.

22. The method of claim 21, further comprising:
generating, in the video path, a realtime graphic overlay comprising scaled video signals,
the overlaying comprising overlaying the received interface graphic on the realtime graphic overlay.

23. A non-transitory computer-readable medium storing instructions which, when executed, perform the method of claim 12.

24. A video switcher comprising:
an input to receive video signals from video sources and a user interface graphic from an external source;
a Central Processing Unit (CPU) to draw realtime graphical elements associated with frames of one or more of the received video signals;
an overlay module to overlay the received interface graphic on the received video signals and realtime graphical elements for presentation in a multiviewer interface.
